(19) United States
(12) Patent Application Publication
(10) Pub. No.: US 2026/0134255 A1
(43) Pub. Date: May 14, 2026

(54) MULTI-TEACHER KNOWLEDGE DISTILLATION USING LOW-RANK ADAPTATION TOWERS

(71) Applicant: NVIDIA CORPORATION, Santa Clara, CA (US)

(72) Inventors: Pavlo MOLCHANOV, Mountain View, CA (US); Michael RANZINGER, Park City, UT (US); Gregory HEINRICH, Nice (FR)

(21) Appl. No.: 19/344,042

(22) Filed: Sep. 29, 2025

Related U.S. Application Data
(60) Provisional application No. 63/720,708, filed on Nov. 14, 2024.

(51) Int. Cl. G06N 3/045; G06N 3/047

(52) U.S. Cl. CPC G06N 3/045; G06N 3/047

(57) ABSTRACT

The disclosed method for training a first machine learning model includes generating, based on training data, first output data using a first teacher machine learning model included in one or more teacher machine learning models, generating, based on the training data, second output data using the first machine learning model, wherein the first machine learning model comprises a second machine learning model and one or more low-rank adaptation (LoRA) towers, calculating, based on the first output data and the second output data, a loss, generating, based on the loss, one or more gradients, generating, based on the one or more gradients, one or more LoRA tower ranks, and updating, based on the loss and the one or more LoRA tower ranks, one or more parameters of the one or more LoRA towers.

### CROSS-REFERENCE TO RELATED APPLICATIONS

This application claims priority benefit of the United States Provisional Patent Application titled, “TECHNIQUES FOR JOINTLY LEARNING TASK SPECIFIC LOW-RANK ADAPTATION TOWERS,” filed on Nov. 14, 2024, and having Ser. No. 63/720,708. The subject matter of this related application is hereby incorporated herein by reference.

### BACKGROUND

### Technical Field

Embodiments of the present disclosure relate generally to computer science, artificial intelligence and machine learning, and, more specifically, to multi-teacher knowledge distillation using low-rank adaptation (LoRA) towers.

### Description of the Related Art

Knowledge distillation refers to the process of training a compact student machine learning model to approximate the behavior of one or more larger teacher machine learning models. Knowledge distillation lies at the intersection of model compression, transfer learning, and multi-task learning, and has broad applications in natural language processing, computer vision, speech recognition, robotics, recommendation systems, and/or the like. A student machine learning model often includes a shared backbone model that captures general-purpose representations together with teacher-specific modules that allow the student to specialize in each of the individual teacher behaviors.

Conventional approaches to knowledge distillation employ low-rank adaptation modules, also referred to as LoRA. In conventional approaches, a pre-trained backbone model is augmented with additional low-rank weight matrices inserted alongside existing layers. During training, the parameters of the backbone model are kept fixed while the low-rank weight matrices are updated, thereby reducing the number of trainable parameters required to adapt the overall model to new tasks or domains. Each LoRA module is characterized by a rank parameter that determines the expressive capacity of the low-rank update. The low-rank matrices project input features into a lower-dimensional space and then back to the original dimension, enabling the overall model to capture task-specific adjustments without modifying the backbone model. LoRA has been applied across a wide range of applications, including natural language processing, computer vision, and speech recognition, to efficiently adapt large pre-trained models.

One drawback of conventional approaches to knowledge distillation with LoRA is the reliance on fixed-rank adaptation modules, which introduces challenges in training efficiency, representation allocation, and overall capacity utilization. For example, assigning the same low-rank dimension across all layers of a neural network can under-allocate capacity to layers that require more expressive power while over-allocating to layers that are less critical, leading to inefficiencies in both performance and parameter usage. The limitations become more pronounced in multi-teacher knowledge distillation settings, where a single student machine learning model must integrate supervision from multiple teacher machine learning models across diverse tasks or domains. In multi-teacher knowledge distillation settings, various teacher machine learning models could demand various amounts of representational capacity at different layers of the backbone model, yet conventional fixed-rank LoRA modules allocate capacity uniformly and cannot adapt dynamically to teacher-specific requirements. The mismatch can lead to suboptimal transfer of knowledge, reduced scalability, and increased computational overhead, ultimately limiting the effectiveness of LoRA in multi-teacher training pipelines.

As the foregoing illustrates, what is needed in the art are more effective techniques for multi-teacher knowledge distillation.

### SUMMARY

According to some embodiments, a computer-implemented method for training a first machine learning model includes generating, based on training data, first output data using a first teacher machine learning model included in one or more teacher machine learning models. The method also includes generating, based on the training data, second output data using the first machine learning model, wherein the first machine learning model comprises a second machine learning model and one or more low-rank adaptation (LoRA) towers. In addition, the method includes calculating, based on the first output data and the second output data, a loss. The method further includes generating, based on the loss, one or more gradients. Furthermore, the method includes generating, based on the one or more gradients, one or more LoRA tower ranks. Additionally, the method includes updating, based on the loss and the one or more LoRA tower ranks, one or more parameters of the one or more LoRA towers.

Further embodiments provide, among other things, non-transitory computer-readable storage media storing instructions and systems configured to implement the method set forth above.

At least one technical advantage of the disclosed techniques relative to the prior art is that the disclosed techniques include dynamic allocation of low-rank capacity across layers and LoRA towers. The dynamic allocation of low-rank capacity permits more efficient use of parameters, improved knowledge transfer from multiple teacher models to a student model, and enhanced scalability across diverse tasks and domains. The disclosed techniques also reduce the computational cost of training and inferencing using the student model by allocating computational resources where the computational resources are most effective. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of the present disclosure;

FIG. 2 is a block diagram of a parallel processing unit included in the parallel processing subsystem of FIG. 1, according to various embodiments of the present disclosure;

FIG. 3 is a block diagram of a general processing cluster included in the parallel processing unit of FIG. 2, according to various embodiments of the present disclosure;

FIG. 4 is a block diagram of a computer system configured to implement one or more aspects of various embodiments;

FIG. 5 is a more detailed illustration of the model trainer of FIG. 4 training the student model of FIG. 4, according to various embodiments;

FIG. 6 is a more detailed illustration of the application of FIG. 4, according to various embodiments;

FIG. 7 is a flow diagram of method steps for training a student model, according to various embodiments; and

FIG. 8 is a flow diagram of method steps for generating output data, according to various embodiments.

### DETAILED DESCRIPTION

In the following description, numerous specific details are set forth to provide a more thorough understanding of the various embodiments. However, it will be apparent to one skilled in the art that the concepts can be practiced without one or more of these specific details.

### General Overview

Embodiments of the present disclosure provide techniques for multi-teacher knowledge distillation using LoRA towers. In some embodiments, the disclosed techniques include a student model and one or more teacher models, which are each machine learning models, such as a neural network. The student model processes input data and generates output data. The student model includes a pretrained backbone model, which is another machine learning model that captures general-purpose representations, and one or more LoRA towers. Each LoRA tower includes one or more sparse weight matrices that specialize the backbone model to a particular teacher model. In some embodiments, a model trainer trains the student model based on training data. During training, the student model processes training data and generates predicted student output data. The teacher models process training data and generate predicted teacher output data. A loss calculator calculates a loss based on the predicted student output data and the predicted teacher output data. The model trainer generates one or more gradients based on the loss. A LoRA tower rank allocator processes the gradients and generates one or more LoRA tower ranks that determine the effective capacity of the LoRA towers under a global rank budget. The model trainer uses the loss and the LoRA tower ranks to iteratively update the parameters of the LoRA towers. Once the student model is trained, an application can use the trained student model to process a task and the input data to generate the output data.

The multi-teacher knowledge distillation techniques of the present disclosure have many real-world applications. For example, the disclosed training techniques can be used in natural language processing platforms to consolidate multiple large language models into a single student model that supports translation, summarization, question answering, and/or the like with reduced computational cost. As another example, the disclosed techniques can be employed in computer vision systems to unify specialized teacher models for detection, segmentation, and depth estimation into one efficient backbone with task-specific modules, enabling deployment in autonomous vehicles or robotics applications. The disclosed techniques may also be used in speech and multimodal systems to integrate diverse teacher models, such as speech recognition, speaker identification, and emotion recognition, into a single student capable of handling multiple audio tasks.

The above examples are not in any way intended to be limiting. As persons skilled in the art will appreciate, as a general matter, the multi-teacher distillation techniques described herein can be implemented in any suitable application.

### System Overview

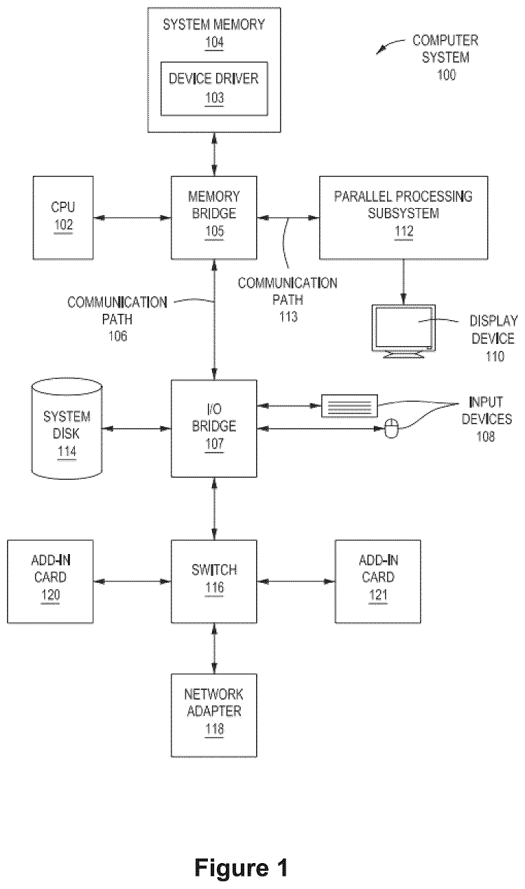

FIG. 1 is a block diagram of a computer system 100 configured to implement one or more aspects of the present disclosure. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116. As persons skilled in the art will appreciate, computer system 100 can be any type of technically feasible computer system, including, without limitation, a server machine, a server platform, a desktop machine, laptop machine, or a hand-held/mobile device. Persons skilled in the art also will appreciate that computer system 100 or systems similar to computer system 100 can be incorporated into a vehicle or machine to facilitate driving, steering, or otherwise controlling that vehicle or machine, as the case may be.

In operation, I/O bridge 107 is configured to receive user input information from input devices 108, such as a keyboard or a mouse, and forward the input information to CPU 102 for processing via communication path 106 and memory bridge 105. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

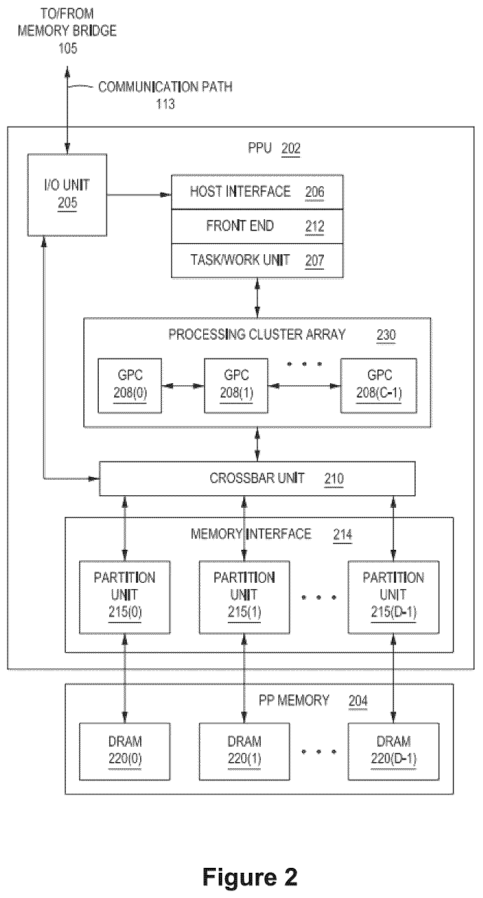

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more other the other elements of FIG. 1 to form a single system. For example, parallel processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the parallel processing subsystem 112 of FIG. 1, according to various embodiments of the present disclosure. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C 1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D 1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPCs 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

As noted above, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

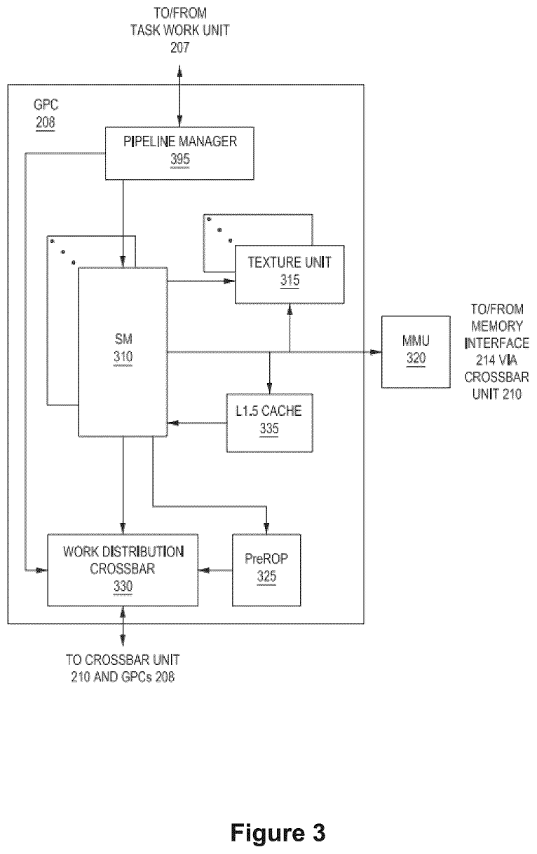

FIG. 3 is a block diagram of a GPC 208 included in PPU 202 of FIG. 2, according to various embodiments of the present disclosure. In operation, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In one embodiment, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (AND, OR, XOR), bit-shifting, and computation of various algebraic functions (e.g., planar interpolation and trigonometric, exponential, and logarithmic functions, etc.). Advantageously, the same functional execution unit can be configured to perform different operations.

In operation, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within the SM 310, in which case some of the execution may be idle during cycles when that thread group is being processed. A thread group may also include more threads than the number of execution units within the SM 310, in which case processing may occur over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 310, and m is the number of thread groups simultaneously active within the SM 310.

Although not shown in FIG. 3, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, the SMs 310 may beneficially share common instructions and data cached in L1.5 cache 335.

Each GPC 208 may have an associated memory management unit (MMU) 320 that is configured to map virtual addresses into physical addresses. In various embodiments, MMU 320 may reside either within GPC 208 or within the memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In graphics and compute applications, GPC 208 may be configured such that each SM 310 is coupled to a texture unit 315 for performing texture mapping operations, such as determining texture sample positions, reading texture data, and filtering texture data.

In operation, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the core architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs. In view of the foregoing, persons of ordinary skill in the art will appreciate that the architecture described in FIGS. 1-3 in no way limits the scope of the present disclosure.

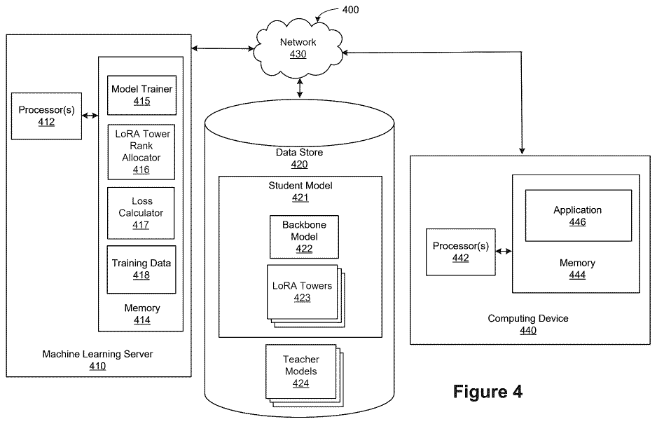

FIG. 4 is a block diagram of a computer system 400 configured to implement one or more aspects of various embodiments. As shown, computer system 400 includes, without limitation, a machine learning server 410, a data store 420, and a computing device 440 in communication over a network 430, which can be a wide area network (WAN) such as the Internet, a local area network (LAN), a cellular network, and/or any other suitable network. Machine learning server 410 includes, without limitation, processor(s) 412 and a memory 414. Memory 414 includes, without limitation, a model trainer 415, LoRA tower rank allocator 416, a loss calculator 417, and training data 418. Data store 420 includes, without limitation, a student model 421 and one or more teacher models 424. Student model 421 includes, without limitation, a backbone model 422 and one or more LoRA towers 423. Computing device 440 includes, without limitation, processor(s) 442 and a memory 444. Memory 444 includes, without limitation, an application 446.

Processor(s) 412 receive user input from input devices, such as a keyboard or a mouse. Processor(s) 412 may include one or more primary processors of machine learning server 410, controlling and coordinating operations of other system components. In particular, processor(s) 412 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

Memory 414 of machine learning server 410 stores content, such as software applications and data, for use by processor(s) 412 and the GPU(s) and/or other processing units. Memory 414 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace memory 414. The storage can include any number and type of external memories that are accessible to processor 412 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

Machine learning server 410 shown herein is for illustrative purposes only, and variations and modifications are possible without departing from the scope of the present disclosure. For example, the number of processors 412, the number of GPUs and/or other processing unit types, the number of memories 414, and/or the number of applications included in memory 414 can be modified as desired. Further, the connection topology between the various units in FIG. 4 can be modified as desired. In some embodiments, any combination of processor(s) 412, memory 414, and/or GPU(s) can be included in and/or replaced with any type of virtual computing system, distributed computing system, and/or cloud computing environment, such as a public, private, or a hybrid cloud system.

As shown, model trainer 415 is an application that executes on the one or more processors 412 of machine learning server 410 and is stored in memory 414 of machine learning server 410. Although shown as distinct from loss calculator 417 and LoRA tower rank allocator 416 for illustrative purposes, in some embodiments, functionality of loss calculator 417, LoRA tower rank allocator 416, and model trainer 415 can be combined into a single application.

In some embodiments, model trainer 415 is configured to train one or more machine learning models, including student model 421. Student model 421 is a machine learning model, such as a neural network, which processes input data and generates output data. In some embodiments, student model 421 includes a transformer-based language model that processes text input, which is an example of the input data, to generate translations, summaries, question-and-answer responses, and/or the like, which are examples of output data. In some embodiments, student model 421 includes a vision encoder that processes image data, which is an example of the input data, to generate object detections, segmentation maps, depth predictions, and/or the like, which are examples of the output data. In some embodiments, student model 421 includes a speech model that processes audio data, which is an example of the input data, to generate transcriptions, speaker identifications, emotion classifications, and/or the like which are examples of the output data.

Backbone model 422 is a pretrained machine learning model, such as a neural network, that processes the input data and generates one or more intermediate feature representations. In some embodiments, backbone model 422 includes. a transformer-based encoder for processing text sequences, a vision transformer or convolutional network for processing image data, a conformer or recurrent network for processing audio data, or another suitable neural architecture depending on the modality of the input data. Backbone model 422 captures general-purpose intermediate representation features that are reused across various tasks.

Each of LoRA towers 423 includes one or more sparse weight matrices that specialize backbone model 422 to a particular teacher model 424. In some embodiments, the sparse weight matrices include low-rank adaptations of the parameters of backbone model 422, enabling teacher-specific or task-specific adjustments to be learned without modifying backbone model 422. In some embodiments, each LoRA tower 423 corresponds to a teacher model 424 or a task and is selectively activated during training or inference depending on which teacher model 424 is supervising student model 421 or which task is being processed. In some embodiments, each LoRA tower 423 is inserted at multiple layers of a transformer-based backbone model 422, including but not limited to multi-head attention projection layers (e.g., query, key, value, and output projections) and feedforward network layers (e.g., first and second fully connected layers of a transformer block).

Teacher models 424 are each machine learning models, such as a neural network, that process the input data and generate predicted teacher output data. In some embodiments, each teacher model 424 includes large, pretrained networks specialized for particular domains or tasks, such as language translation, text summarization, image segmentation, object detection, speech recognition, or other modalities.

Loss calculator 417 is an application that calculates a loss based on predicted student output data generated by student model 421 and the predicted teacher output data. In some embodiments, the loss includes a distillation loss, such as a Kullback-Leibler (KL) divergence between probability distributions of student model 421 and the teacher model 424, a mean squared error between intermediate feature representations, or another suitable objective function. In some embodiments, model trainer 115 processes the loss and generates one or more gradients.

Training data 418 includes the input data for various tasks corresponding to various teacher models 424. For example, training data 418 can include text sequences for natural language tasks, such as translation or summarization, image data for computer vision tasks, such as detection or segmentation, audio recordings for speech recognition or speaker identification tasks, and multimodal data for tasks that combine language, vision, or audio. Each subset of the training data 418 corresponds to a teacher model 424 that supervises the student model 421 for the associated task.

LoRA tower rank allocator 416 is an application that processes the gradients generated by the model trainer and generates one or more LoRA tower ranks. In some embodiments, LoRA tower rank allocator 416 determines the relative importance of different rank channels included in each LoRA tower 423 by computing saliency scores based on the magnitudes of the gradients, exponential moving averages, or other statistical measures of parameter contribution. LoRA rank allocator 416 then redistributes a global rank budget across layers and teacher-specific LoRA towers 423 according to the computed saliency, thereby pruning low-importance channels included in each LoRA tower 423 and allocating additional capacity to high-importance channels included in each LoRA tower 423. In some embodiments, LoRA tower rank allocator 416 enforces a constraint that the total rank across all LoRA towers 423 and layers does not exceed a maximum budget.

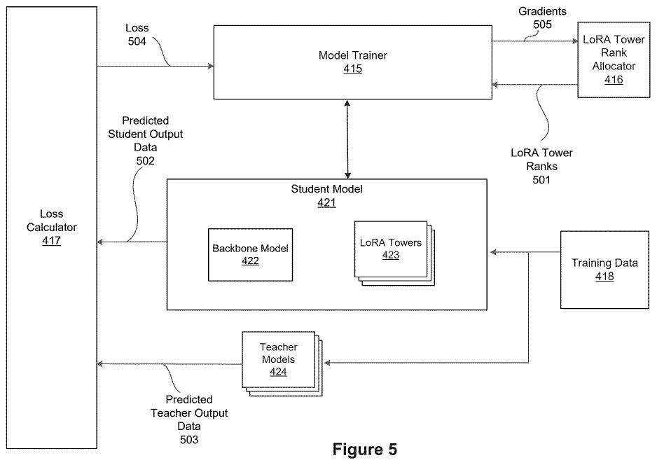

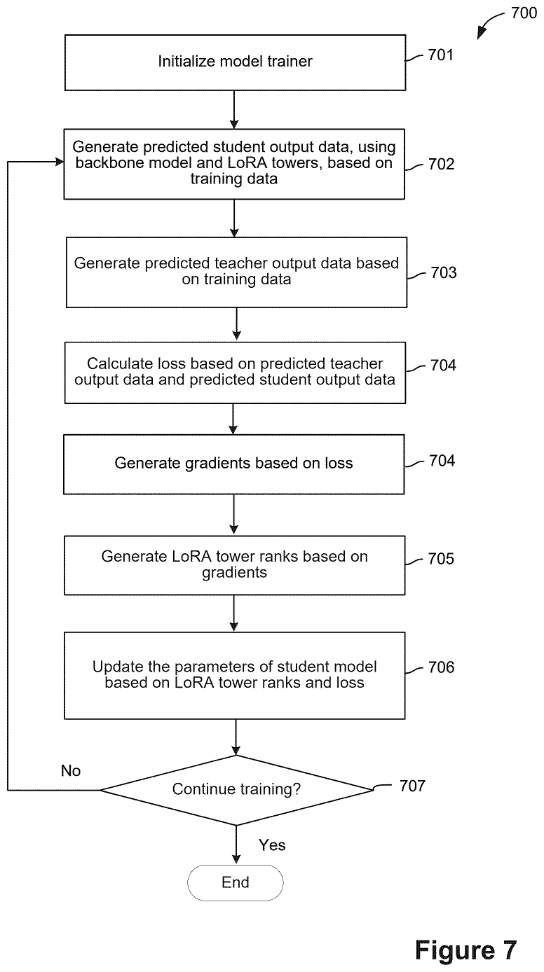

In some embodiments, model trainer 415 trains the student model 421 based on training data 418. During training, model trainer 415 uses the loss and the LoRA tower ranks 501 to iteratively update LoRA towers 423 and optionally backbone model 422 until one or more stopping criteria are met. Once the training stops, model trainer 415 stores the trained student model 421 in data store 420 or elsewhere. Model trainer 415 is described in greater detail in conjunction with FIGS. 5 and 7.

In some embodiments, data store 420 includes any storage device or devices, such as fixed disc drive(s), flash drive(s), optical storage, network attached storage (NAS), and/or a storage area-network (SAN). Although shown as accessible over network 430, in at least one embodiment, machine learning server 410 can include data store 420.

Computing device 440 shown herein is for illustrative purposes only, and variations and modifications in the design and arrangement of computing device 440, without departing from the scope of the present disclosure. For example, the number of processor(s) 442, the number of and/or type of memories 444, and/or the number of applications and/or data stored in memory 444 can be modified as desired. In some embodiments, any combination of processor(s) 442 and/or memory 444 can be included in and/or replaced with any type of virtual computing system, distributed computing system, and/or cloud computing environment, such as a public, private, or a hybrid cloud system.

Each of processor(s) 442 can be any suitable processor, such as a CPU, a GPU, an ASIC, an FPGA, a DSP, a multicore processor, and/or any other type of processing unit, or a combination of two or more of a same type and/or different types of processing units, such as a SoC, or a CPU configured to operate in conjunction with a GPU. In general, processor(s) 442 can be any technically feasible hardware unit capable of processing data and/or executing software applications. During operation, processor(s) 442 can receive user input from input devices (not shown), such as a keyboard or a mouse.

Memory 444 of computing device 440 stores content, such as software applications and data, for use by processor(s) 442. As shown, memory 444 includes, without limitation, video generation application 446. Memory 444 can be any type of memory capable of storing data and software applications, such as a RAM, a ROM, an EPROM or a Flash ROM, or any suitable combination of the foregoing. In some embodiments, additional storage (not shown) can supplement or replace memory 444. The storage can include any number and type of external memories that are accessible to processor(s) 442. For example, and without limitation, the storage can include a Secure Digital Card, an external Flash memory, a portable CD-ROM, an optical storage device, a magnetic storage device, and/or any suitable combination of the foregoing.

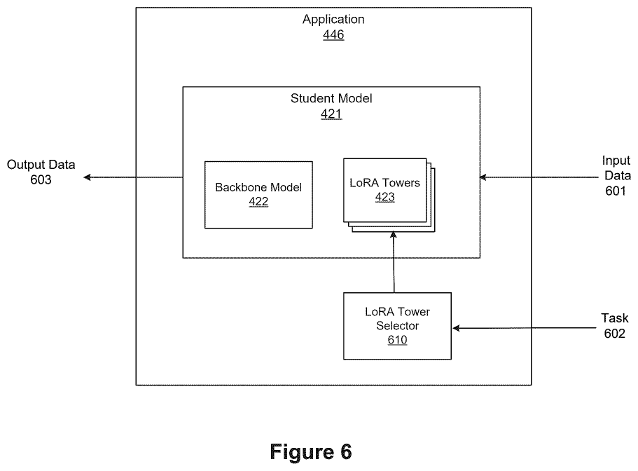

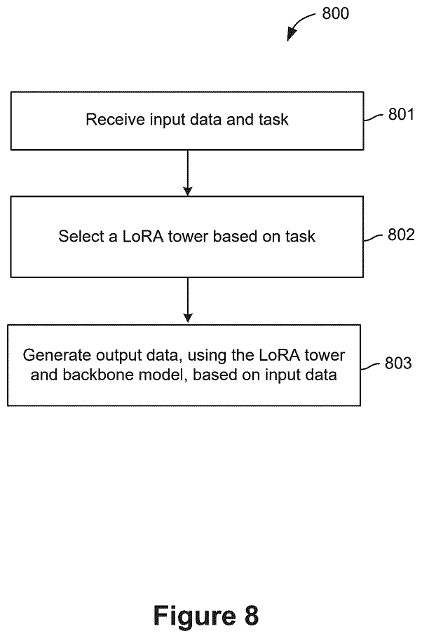

As shown, application 446 is stored in memory 444 and executes on processor(s) 442. Application 446 uses, the trained student model 421 to process the input data and a task received from one or more I/O devices and generate the output data. In some embodiments, the task includes a task identifier (ID) that specifies which task is to be performed, such as translation, summarization, object detection, speech recognition, or another supported function. In some embodiments, application 446 includes a LoRA tower selector which processes the task and selects an appropriate LoRA tower 423 corresponding to the task. In some embodiments, LoRA tower selector 610 maps the task ID to a particular LoRA tower 423 using a rule-based mapping or using a learned routing mechanism that analyzes the task ID or properties of the input data to determine which LoRA tower 423 to activate. Once selected, the LoRA tower 423 is combined with backbone model 422 to process the input data and generate the output data. Application 446 is described in greater detail in conjunction with FIGS. 6 and 8.

FIG. 5 is a more detailed illustration of the model trainer 415 training the student model 421, according to various embodiments. As shown, student model 421 includes backbone model 422 and LoRA towers 423. In operation, student model 421 uses LoRA towers 423 and backbone model 422 to process training data 418 and generate predicted student output data 502. Teacher models 424 process training data 418 and generate predicted teacher output data 503. Loss calculator 417 calculates loss 504 based on predicted student output data 502 and predicted teacher output data 503. Model trainer 415 processes loss 504 and generates one or more gradients 505. LoRA tower rank allocator 416 processes gradients 505 and generates LoRA tower ranks 501. Model trainer 115 uses loss 504 and LoRA tower ranks 501 to iteratively update the parameters of LoRA towers 423 and optionally the parameters of backbone model 422.

Student model 421 processes training data 418 and generates predicted student output data 502. Backbone model 422 processes the input data included in training data 418 and generates one or more intermediate feature representations. Backbone model 422 captures general-purpose intermediate representation features that are reused across various tasks. In some examples, given an input data x included in training data 418, backbone model 422 parameterized by weights θ_{B} computes an intermediate feature representation h according to:

$$h = f ( x ; {θ}_{B} ) , \qquad ( Equation 1 )$$

where f(⋅) denotes the backbone function and θ_{B}={ [symbol] | [symbol] ∈ [symbol] }, where [symbol] is the weight matrix for layer [symbol] included in backbone model 422.

Each of LoRA towers 423 includes one or more sparse weight matrices that specialize backbone model 422 to a particular teacher model 424. In some embodiments, the sparse weight matrices include low-rank adaptations of the parameters of backbone model 422, such that for a backbone weight matrix [symbol] ∈ [symbol] at layer [symbol] . For example, the effective weight when LoRA tower 423 t is active is given by:

$${W}_{ℓ , t}^{eff} = {W}_{ℓ} + {α}_{ℓ , t} {A}_{ℓ , t} {B}_{ℓ , t} , \qquad ( Equation 2 )$$

where [symbol] ∈ [symbol] , [symbol] ∈ [symbol] , [symbol] is the rank of the adaptation, and [symbol] is a scaling factor.

In some embodiments, each LoRA tower 423 corresponds to a teacher model 424 and is selectively activated during training or inference depending on which teacher model 424 is in supervision or which task is being processed. In some embodiments, each LoRA tower 423 is inserted at multiple layers of a transformer-based backbone model 422. For a multi-head attention block at layer [symbol] , backbone model 422 includes projection matrices for queries

$${W}_{ℓ}^{Q} ,$$

keys

$${W}_{ℓ}^{K} ,$$

values

$${W}_{ℓ}^{V} ,$$

and outputs

$${W}_{ℓ}^{O} .$$

In some examples, the corresponding effective weights under tower t are expressed as:

$${( {W}_{ℓ}^{Q} )}_{t}^{eff} = {W}_{ℓ}^{Q} + {α}_{ℓ , t}^{Q} {A}_{ℓ , t}^{Q} {B}_{ℓ , t}^{Q} , \qquad ( Equation 3 )$$

$${( {W}_{ℓ}^{K} )}_{t}^{eff} = {W}_{ℓ}^{K} + {α}_{ℓ , t}^{K} {A}_{ℓ , t}^{K} {B}_{ℓ , t}^{K} ,$$

$${( {W}_{ℓ}^{V} )}_{t}^{eff} = {W}_{ℓ}^{V} + {α}_{ℓ , t}^{V} {A}_{ℓ , t}^{V} {B}_{ℓ , t}^{V} ,$$

$${( {W}_{ℓ}^{O} )}_{t}^{eff} = {W}_{ℓ}^{O} + {α}_{ℓ , t}^{O} {A}_{ℓ , t}^{O} {B}_{ℓ , t}^{O} .$$

For the feedforward network within the transformer block, which typically includes two fully connected layers with weights

$${W}_{ℓ}^{FC 1} and {W}_{ℓ}^{F C 2} ,$$

the effective weights under LoRA tower 423 t are expressed, for example, as:

$${( {W}_{ℓ}^{F C 1} )}_{t}^{eff} = {W}_{ℓ}^{F C 1} + {α}_{ℓ , t}^{F C 1} {A}_{ℓ , t}^{F C 1} {B}_{ℓ , t}^{F C 1} , \qquad ( Equation 4 )$$

$${( {W}_{ℓ}^{F C 2} )}_{t}^{eff} = {W}_{ℓ}^{F C 2} + {α}_{ℓ , t}^{F C 2} {A}_{ℓ , t}^{F C 2} {B}_{ℓ , t}^{F C 2} .$$

When activated, LoRA tower 423 modifies the forward computation by replacing each backbone projection or feedforward weight with the corresponding effective weight as described in Equations 2-4, thereby generating teacher-specific or task-specific adaptations while retaining the shared capacity of backbone model 422. In some examples, the final predicted student output data 502 y_{S} with active LoRA tower 423 t is then given by:

$${y}_{S} = g ( x ; {\{ {W}_{ℓ , t}^{eff} \}}_{ℓ ∈ ℒ} ) , \qquad ( Equation 5 )$$

where g(⋅) denotes the full forward pass through backbone model 422 augmented with the active LoRA tower 423.

Teacher models 424 are each machine learning models, such as a neural network, that process training data 418 and generate predicted teacher output data 503. In some embodiments, each teacher model 424 includes large, pretrained networks specialized for particular domains or tasks, such as language translation, text summarization, image segmentation, object detection, speech recognition, or other modalities.

Loss calculator 417 is an application that calculates loss 504 based on predicted student output data 502 and predicted teacher output data 503. In some embodiments, loss 504 includes a distillation loss, such as a KL divergence between probability distributions of student model 421 and the active teacher model 424, a mean squared error between intermediate feature representations, or another suitable objective function. For example, when predicted teacher output data 503 are denoted as y_{T,i} and predicted student output data 502 as y_{S,i}, the distillation loss can be expressed as:

$${ℒ}_{K D} = {T}^{2} {\sum }_{i = 1}^{B} ( σ ( {y}_{T , i} / τ ) \vert \vert σ ( {y}_{S , i} / τ ) ) + {λ}_{task} {ℒ}_{task} , \qquad ( Equation 6 )$$

where T is a temperature scaling factor, σ(⋅) denotes the softmax function, τ is a temperature parameter, and λₜₐₛₖ is a weighting coefficient for a task-specific loss. In some embodiments, loss 504 further includes a regularization term applied to the low-rank matrices included in LoRA towers 423 and optionally applied to the parameters of the backbone model 422, for example, expressed as:

$$ℛ = {\sum }_{ℓ , t , k} ( {‖ {A}_{ℓ , t , k} ‖}_{F}^{2} + {‖ {B}_{ℓ , t , k} ‖}_{F}^{2} ) + {λ}_{B} {‖ {θ}_{B} - {θ}_{B}^{( 0 )} ‖}_{2}^{2} , \qquad ( Equation 7 )$$

where [symbol] , [symbol] are low-rank matrices for layer [symbol] , LoRA tower 423 t, and channel k, θ_{B} are the backbone parameters,

$${θ}_{B}^{( 0 )}$$

are the pretrained backbone parameters, and ∥⋅∥_{F} is the Frobenius norm. In some embodiments, loss calculator 417 calculates loss 504 based on the distillation loss and the regularization loss, for example, described as:

$$𝒥 = {ℒ}_{K D} + {λ}_{reg} ℛ , \qquad ( Equation 8 )$$

where λ_{reg} controls the strength of the regularization.

In some embodiments, model trainer 415 processes loss 504 and generates gradients 505. In some embodiments, model trainer 115 computes gradients 505 with respect to the total objective [symbol] as described in Equation 8. In some examples, for the low-rank matrices [symbol] and [symbol] included in LoRA tower 423, gradients 505 are expressed as [symbol] and [symbol] , which represent how the objective [symbol] changes with respect to each low-rank adaptation. In some embodiments, gradients 505 are computed for each rank channel i of the low-rank matrices included in LoRA towers 423, yielding partial derivatives such as

$$\frac{\partial 𝒥}{\partial {A}_{ℓ , t , k}^{( : , i )}} and \frac{\partial 𝒥}{\partial {B}_{ℓ , t , k}^{( i , : )}} ,$$

where

$${A}_{ℓ , t , k}^{( : , i )} , {B}_{ℓ , t , k}^{( i , : )}$$

denote the i-th rank channel of the low-rank matrices included in LoRA towers 423.

LoRA tower rank allocator 416 is an application that processes gradients 505 generated by model trainer 415 and generates one or more LoRA tower ranks 501. In some embodiments, LoRA tower rank allocator 416 determines the relative importance of different rank channels included in each LoRA tower 423 by computing saliency scores based on the magnitudes of gradients 505. In some examples, for a rank channel i of matrices [symbol] , [symbol] , the saliency score can be expressed as:

$${s}_{ℓ , t , k , i} ∝ {‖ \frac{\partial 𝒥}{\partial {A}_{ℓ , t , k}^{( : , i )}} ‖}_{2} \cdot {‖ \frac{\partial 𝒥}{\partial {B}_{ℓ , t , k}^{( i , : )}} ‖}_{2} . \qquad ( Equation 9 )$$

In some embodiments, the saliency values are accumulated using an exponential moving average across training steps for stability. LoRA tower rank allocator 416 then uses the saliency scores to generate LoRA tower ranks 501 by selecting the top-scoring rank channels until a global rank budget is met. Specifically, across all layers and LoRA towers 423, channels with higher saliency are assigned active rank, while channels with lower saliency are pruned. In some embodiments, the total number of active ranks included in LoRA tower ranks 501 is constrained by a budget Rₜₒₜ, such that:

$${\sum }_{ℓ , t} {r}_{ℓ , t} \leq {R}_{t o t} , \qquad ( Equation 10 )$$

where [symbol] denotes the rank allocated to LoRA tower 423 t at layer [symbol] . The resulting LoRA tower ranks 501 specify, for each LoRA tower 423 and layer, how many low-rank channels remain active.

In some embodiments, model trainer 415 updates the parameters of LORA towers 423 and optionally the parameters of backbone model 422 based on loss 504 and LoRA tower ranks 501. In some embodiments, model trainer 415 initializes matrices [symbol] with small random values (e.g., Gaussian noise) while matrices [symbol] are initialized to zero. In some embodiments, LoRA tower ranks 501 specify which rank channels remain active in each LoRA tower 423, and model trainer 415 applies gradient updates only to the active channels. Channels that are pruned based on LoRA tower ranks 501 do not receive further updates, while channels that are grown receive additional capacity for training. In some examples, for active parameters θ∈{θ_{B}, [symbol] , [symbol] }, the update rule can be expressed as:

$$θ ← θ - η {M}_{ℓ , t} ⊙ {∇}_{θ} 𝒥 , \qquad ( Equation 11 )$$

where η is a learning rate, [symbol] is the gradient of the objective function, [symbol] is a binary mask derived from LoRA tower ranks 501 that indicates which channels are active, and ⊙ denotes element-wise multiplication.

In some embodiments, model trainer 415 continues updating the parameters of student model 421 until a stopping criterion is satisfied. The stopping criterion can be based on one or more conditions, such as convergence of the objective function [symbol] , stabilization of validation loss, attainment of a target performance threshold on evaluation data included in training data 418, or completion of a predefined number of training epochs or steps. In some embodiments, stopping criteria also include monitoring the distribution of LoRA tower ranks 501, such that training could terminate when rank allocations converge and no further significant reallocations occur across layers and LoRA towers 423. In some embodiments, early stopping is employed to prevent overfitting by halting training when a validation loss ceases to improve for a specified number of iterations. Once the stopping criterion is satisfied, model trainer 415 stores the trained student model 421 in data store 420 or elsewhere.

FIG. 6 is a more detailed illustration of application 446, according to various embodiments. As shown, application 446 includes student model 421 and LoRA tower selector 610. Student model 421 includes LoRA towers 423 and backbone model 422. In operation, LoRA tower selector 610 processes task 602 and selects the appropriate LoRA tower 423 for task 602. Student model 421 uses backbone model 422 and the selected LoRA tower 423 to process input data 601 and generate output data 603.

LoRA tower selector 610 is an application which processes task 602 and selects an appropriate LoRA tower 423 corresponding to task 602. In some embodiments, LoRA tower selector 610 maps a task ID included in task 602 to a particular LoRA tower 423 using a rule-based mapping or using a learned routing mechanism that analyzes the task ID or properties of the input data to determine which LoRA tower 423 to activate. In some embodiments, LoRA tower selector 610 processes task 602, which includes a task ID, and maps the task ID to an index t=π(task ID) of a particular LoRA tower 423, where π(⋅) is a mapping function from the task IDs to the indices of LoRA towers 423.

Student model 421 uses backbone model 422 and the selected LoRA tower 423 to process input data 601 and generate output data 603. In some embodiments, backbone model 422 is a machine learning model, such as a neural network, that processes the input data and generates the intermediate feature representations. In some embodiments, backbone model 422 includes a suitable neural architecture selected depending on the modality of input data 601. In some embodiments, the sparse weight matrices of the selected LoRA tower 423 provide low-rank adaptations of the parameters of backbone model 422, such that for a backbone weight matrix [symbol] ∈ [symbol] at layer [symbol] , the effective weight when LoRA tower 423 t is active, for example, given by Equation 2. The output data 603 generated by student model 421 with selected LoRA tower 423 t is then, for example, given by Equation 3.

FIG. 7 is a flow diagram of method steps for training student model 421, according to various embodiments. Although the method steps are described in conjunction with the systems of FIGS. 1-5, persons skilled in the art will understand that any system configured to perform the method steps in any order falls within the scope of the present disclosure.

A method 700 begins with step 701, where model trainer 415 is initialized. In some embodiments, initialization includes setting a total number of training epochs, a learning rate n as described in Equation 11, initial LoRA tower ranks 501, and other parameters used in optimization. For example, initialization can include allocating a global rank budget Rₜₒₜ across LoRA towers 423 and layers of backbone model 422, and initializing exponential moving average coefficients for saliency score computation in LoRA tower rank allocator 416. In some embodiments, initialization further includes loading pretrained backbone weights θ_{B}, and initializing the low-rank matrices of LORA towers 423. In some embodiments, model trainer 415 initializes matrices [symbol] with small random values (e.g., Gaussian noise) while matrices [symbol] are initialized to zero. In addition, initialization includes setting the loss weighting coefficients that control contributions of different objective components. For example, initialization can include setting Δₜₐₛₖ as given in Equation 6, λ_{B} as given in Equation 7, and λ_{reg} as given in Equation 8.

At step 702, student model 421 generates predicted student output data 502, using backbone model 422 and LoRA towers 423, based on training data 418. Backbone model 422 processes the input data included in training data 418 and generates one or more intermediate feature representations. In some examples, given an input data x included in training data 418, backbone model 422 parameterized by weights θ_{B} computes an intermediate feature representation h according to Equation 1. Each of LoRA towers 423 includes one or more sparse weight matrices that specialize backbone model 422 to a particular teacher model 424. In some embodiments, the sparse weight matrices include low-rank adaptations of the parameters of backbone model 422, such that for a backbone weight matrix [symbol] ∈ [symbol] at layer [symbol] . For example, the effective weight when LoRA tower 423 t is active is given by Equation 2. In some embodiments, each LoRA tower 423 corresponds to a teacher model 424 and is selectively activated during training depending on which teacher model 424 is in supervision or which task is being processed.

At step 703, teacher models 424 generates predicted teacher output data 503 based on training data 418. In some embodiments, each teacher model 424 includes large, pretrained networks specialized for particular domains or tasks, such as language translation, text summarization, image segmentation, object detection, speech recognition, or other modalities.

At step 704, loss calculator 417 calculates loss 504 based on predicted teacher output data 503 and predicted student output data 502. In some embodiments, loss 504 includes a distillation loss, such as a KL divergence between probability distributions of student model 421 and the active teacher model 424, a mean squared error between intermediate feature representations, or another suitable objective function. For example, when predicted teacher output data 503 are denoted as y_{T,i} and predicted student output data 502 as y_{S,i}, the distillation loss can be expressed as described in Equation 6. In some embodiments, loss 504 further includes a regularization term applied to the low-rank matrices included in LoRA towers 423 and optionally applied to the parameters of the backbone model 422, for example, as described in Equation 7. In some embodiments, loss calculator 417 calculates loss 504 based on the distillation loss and the regularization loss, for example, as described in Equation 8.

At step 704, model trainer 115 generates gradients 505 based on loss 504. In some embodiments, model trainer 115 computes gradients 505 with respect to the total objective [symbol] as described in Equation 8. In some examples, for the low-rank matrices [symbol] and [symbol] included in LoRA tower 423, gradients 505 are expressed as [symbol] and [symbol] , which represent how the objective [symbol] changes with respect to each low-rank adaptation. In some embodiments, gradients 505 are computed for each rank channel i of the low-rank matrices included in LoRA towers 423, yielding partial derivatives such as

$$\frac{\partial 𝒥}{\partial {A}_{ℓ , t , k}^{( : , i )}} and \frac{\partial 𝒥}{\partial {B}_{ℓ , t , k}^{( i , : )}} ,$$

where

$${A}_{ℓ , t , k}^{( : , i )} , {B}_{ℓ , t , k}^{( i , : )}$$

denote the i-th rank channel of the low-rank matrices included in LoRA towers 423.

At step 705, LoRA tower rank allocator 416 generates LoRA tower ranks 501 based on gradients 505. In some embodiments, LoRA tower rank allocator 416 determines the relative importance of different rank channels included in each LoRA tower 423 by computing saliency scores based on the magnitudes of gradients 505. In some examples, for a rank channel i of matrices [symbol] , [symbol] , the saliency score can be described as given in Equation 9. In some embodiments, the saliency values are accumulated using an exponential moving average across training steps for stability. LoRA tower rank allocator 416 then uses the saliency scores to generate LoRA tower ranks 501 by selecting the top-scoring rank channels until a global rank budget is met. Specifically, across all layers and LoRA towers 423, channels with higher saliency are assigned active rank, while channels with lower saliency are pruned. In some embodiments, the total number of active ranks included in LoRA tower ranks 501 is constrained by a budget Rₜₒₜ, as described in Equation 10.

At step 706, model trainer 415 updates the parameters of student model 421 based on LoRA tower ranks 501 and loss 504. In some embodiments, model trainer 415 updates the parameters of LORA towers 423 and optionally the parameters of backbone model 422 based on loss 504 and LoRA tower ranks 501. In some embodiments, LoRA tower ranks 501 specify which rank channels remain active in each LoRA tower 423, and model trainer 415 applies gradient updates only to the active channels. Channels that are pruned based on LoRA tower ranks 501 do not receive further updates, while channels that are grown receive additional capacity for training. In some examples, for active parameters θ∈{θ_{B}, [symbol] , [symbol] }, the update rule can be expressed as described in Equation 11.

At step 707, model trainer 415 determines whether to continue training. In some embodiments, model trainer 415 continues updating the parameters of student model 421 until a stopping criterion is satisfied. The stopping criterion can be based on one or more conditions, such as convergence of the objective function [symbol] , stabilization of validation loss, attainment of a target performance threshold on evaluation data included in training data 418, or completion of a predefined number of training epochs or steps. In some embodiments, stopping criteria also include monitoring the distribution of LoRA tower ranks 501, such that training could terminate when rank allocations converge and no further significant reallocations occur across layers and LoRA towers 423. In some embodiments, early stopping is employed to prevent overfitting by halting training when a validation loss ceases to improve for a specified number of iterations. Whenever model trainer 415 determines to continue training, the method 700 returns to step 702. Whenever model trainer 415 determines not to continue training, the method 700 terminates and model trainer 415 stores the trained student model 421 in data store 420 or elsewhere.

FIG. 8 is a flow diagram of method steps for generating output data 603, according to various embodiments. Although the method steps are described in conjunction with the systems of FIGS. 1-6, persons skilled in the art will understand that any system configured to perform the method steps in any order falls within the scope of the present disclosure.

As shown, a method 800 begins with step 801, where student model 421 receives input data 601 and LoRA tower selector 610 receives task 602. In some embodiments, input data 601 and task 602 are received via one or more I/O devices.

At step 802, LoRA tower selector 610 selects LoRA tower 423 based on task 602. In some embodiments, LoRA tower selector 610 maps a task ID included in task 602 to a particular LoRA tower 423 using a rule-based mapping or using a learned routing mechanism that analyzes the task ID or properties of the input data to determine which LoRA tower 423 to activate. In some embodiments, LoRA tower selector 610 processes task 602, which includes a task ID, and maps the task ID to an index t=π(task ID) of a particular LoRA tower 423, where π(⋅) is a mapping function from the task IDs to the indices of LoRA towers 423.

At step 803, student model 421 generates output data 603, using the LoRA tower 423 and backbone model 422, based on input data 601. In some embodiments, backbone model 422 processes input data 601 and generates the intermediate feature representations. In some embodiments, backbone model 422 includes. a transformer-based encoder for processing text sequences, a vision transformer or convolutional network for processing image data, a conformer or recurrent network for processing audio data, or another suitable neural architecture depending on the modality of input data 601. In some embodiments, the sparse weight matrices of the selected LoRA tower 423 provide low-rank adaptations of the parameters of backbone model 422, such that for a backbone weight matrix [symbol] ∈ [symbol] at layer [symbol] , the effective weight when LoRA tower 423 t is active, for example, given by Equation 2. The output data 603 generated by student model 421 with selected LoRA tower 423 t is then, for example, given by Equation 3.

In sum, techniques are disclosed for multi-teacher knowledge distillation using LoRA towers. In some embodiments, the disclosed techniques include a student model and one or more teacher models, which are each machine learning models, such as a neural network. The student model processes input data and generates output data. The student model includes a pretrained backbone model, which is another machine learning model that captures general-purpose representations, and one or more LoRA towers. Each LoRA tower includes one or more sparse weight matrices that specialize the backbone model to a particular teacher model. In some embodiments, a model trainer trains the student model based on training data. During training, the student model processes training data and generates predicted student output data. The teacher models process training data and generate predicted teacher output data. A loss calculator calculates a loss based on the predicted student output data and the predicted teacher output data. The model trainer generates one or more gradients based on the loss. A LoRA tower rank allocator processes the gradients and generates one or more LoRA tower ranks that determine the effective capacity of the LoRA towers under a global rank budget. The model trainer uses the loss and the LoRA tower ranks to iteratively update the parameters of the LoRA towers. Once the student model is trained, an application can use the trained student model to process a task and the input data to generate the output data.

At least one technical advantage of the disclosed techniques relative to the prior art is that the disclosed techniques include dynamic allocation of low-rank capacity across layers and LoRA towers. The dynamic allocation of low-rank capacity permits more efficient use of parameters, improved knowledge transfer from multiple teacher models to a student model, and enhanced scalability across diverse tasks and domains. The disclosed techniques also reduce the computational cost of training and inferencing using the student model by allocating computational resources where the computational resources are most effective. These technical advantages provide one or more technological improvements over prior art approaches.

1. In some embodiments, a computer-implemented method for training a first machine learning model comprises generating, based on training data, first output data using a first teacher machine learning model included in one or more teacher machine learning models, generating, based on the training data, second output data using the first machine learning model, wherein the first machine learning model comprises a second machine learning model and one or more low-rank adaptation (LoRA) towers, calculating, based on the first output data and the second output data, a loss, generating, based on the loss, one or more gradients, generating, based on the one or more gradients, one or more LoRA tower ranks, and updating, based on the loss and the one or more LoRA tower ranks, one or more parameters of the one or more LoRA towers.

2. The computer-implemented method of clause 1, further comprising updating, based on the loss and the one or more LoRA tower ranks, one or more parameters of the second machine learning model.

3. The computer-implemented method of clauses 1 or 2, wherein each LoRA tower included in the one or more LoRA towers corresponds to a respective teacher machine learning model included in one or more teacher machine learning models.

4. The computer-implemented method of any of clauses 1-3, wherein each LoRA tower included in the one or more LoRA towers comprises one or more sparse weight matrices that specialize the second machine learning model to the first teacher model.

5. The computer-implemented method of any of clauses 1-4, wherein each LoRA tower included in the one or more LoRA towers is inserted at one or more layers of the second machine learning model.

6. The computer-implemented method of any of clauses 1-5, wherein calculating the loss comprises calculating a Kullback-Leibler (KL) divergence between a probability distribution generated by the first machine learning model and a probability distribution generated by the first teacher machine learning model.

7. The computer-implemented method of any of clauses 1-6, wherein the one or more gradients comprise one or more gradients of the loss with respect to at least one of one or more low-rank matrices included in the one or more LoRA towers or one or more rank channels included in the one or more the low-rank matrices.

8. The computer-implemented method of any of clauses 1-7, wherein generating the one or more LoRA tower ranks comprises computing, based on one or more magnitudes of the one or more gradients, one or more saliency scores, and generating, based on the one or more saliency scores, the one or more LoRA tower ranks.

9. The computer-implemented method of any of clauses 1-8, wherein generating the one or more LoRA tower ranks further comprises applying an exponential moving average to the one or more saliency scores across one or more training steps.

10. The computer-implemented method of any of clauses 1-9, wherein a total number of the one or more LoRA tower ranks is constrained by a budget.

11. The computer-implemented method of any of clauses 1-10, further comprising receiving input data and a task, selecting, based on a task identifier included in the task, a first LoRA tower included in the one or more LoRA towers, and generating, based on the input data, output data using the first LoRA tower and the second machine learning model.

12. The computer-implemented method of any of clauses 1-11, wherein selecting the first LoRA tower comprises mapping the task identifier to the first LoRA tower using at least one of a rule-based mapping, or a learned routing mechanism.

13. The computer-implemented method of any of clauses 1-12, wherein updating the one or more parameters of the one or more LoRA towers comprises updating, based on the loss and one or more LoRA tower ranks, one or more parameters of one or more channels with active rank included in the one or more LoRA towers.

14. In some embodiments, one or more non-transitory computer-readable media store instructions that, when executed by one or more processors, cause the one or more processors to perform the steps of generating, based on training data, first output data using a first teacher machine learning model included in one or more teacher machine learning models, generating, based on the training data, second output data using the first machine learning model, wherein the first machine learning model comprises a second machine learning model and one or more low-rank adaptation (LoRA) towers, calculating, based on the first output data and the second output data, a loss, generating, based on the loss, one or more gradients, generating, based on the one or more gradients, one or more LoRA tower ranks, and updating, based on the loss and the one or more LoRA tower ranks, one or more parameters of the one or more LoRA towers.

15. The one or more non-transitory computer-readable media of clause 14, wherein each LoRA tower included in the one or more LoRA towers corresponds to a respective teacher machine learning model included in one or more teacher machine learning models.

16. The one or more non-transitory computer-readable media of clauses 14 or 15, wherein each LoRA tower included in the one or more LoRA towers is inserted at one or more layers of the second machine learning model.

17. The one or more non-transitory computer-readable media of any of clauses 14-16, wherein calculating the loss comprises calculating a Kullback-Leibler (KL) divergence between a probability distribution generated by the first machine learning model and a probability distribution generated by the first teacher machine learning model.

18. The one or more non-transitory computer-readable media of any of clauses 14-17, wherein the one or more gradients comprise one or more gradients of the loss with respect to at least one of one or more low-rank matrices included in the one or more LoRA towers or one or more rank channels included in the one or more the low-rank matrices.

19. The one or more non-transitory computer-readable media of any of clauses 14-18, wherein generating the one or more LoRA tower ranks comprises computing, based on one or more magnitudes of the one or more gradients, one or more saliency scores, and generating, based on the one or more saliency scores, the one or more LoRA tower ranks.

20. In some embodiments, a system comprises one or more memories storing instructions, and one or more processors that are coupled to the one or more memories and, when executing the instructions, are configured to generate, based on training data, first output data using a first teacher machine learning model included in one or more teacher machine learning models, generate, based on the training data, second output data using the first machine learning model, wherein the first machine learning model comprises a second machine learning model and one or more low-rank adaptation (LoRA) towers, calculate, based on the first output data and the second output data, a loss, generate, based on the loss, one or more gradients, generate, based on the one or more gradients, one or more LoRA tower ranks, and update, based on the loss and the one or more LoRA tower ranks, one or more parameters of the one or more LoRA towers.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training a first machine learning model, the method comprising:
generating, based on training data, first output data using a first teacher machine learning model included in one or more teacher machine learning models;
generating, based on the training data, second output data using the first machine learning model, wherein the first machine learning model comprises a second machine learning model and one or more low-rank adaptation (LoRA) towers;
calculating, based on the first output data and the second output data, a loss;
generating, based on the loss, one or more gradients;
generating, based on the one or more gradients, one or more LoRA tower ranks; and
updating, based on the loss and the one or more LoRA tower ranks, one or more parameters of the one or more LoRA towers.

2. The computer-implemented method of claim 1, further comprising updating, based on the loss and the one or more LoRA tower ranks, one or more parameters of the second machine learning model.

3. The computer-implemented method of claim 1, wherein each LoRA tower included in the one or more LoRA towers corresponds to a respective teacher machine learning model included in one or more teacher machine learning models.

4. The computer-implemented method of claim 1, wherein each LoRA tower included in the one or more LoRA towers comprises one or more sparse weight matrices that specialize the second machine learning model to the first teacher model.

5. The computer-implemented method of claim 1, wherein each LoRA tower included in the one or more LoRA towers is inserted at one or more layers of the second machine learning model.

6. The computer-implemented method of claim 1, wherein calculating the loss comprises calculating a Kullback-Leibler (KL) divergence between a probability distribution generated by the first machine learning model and a probability distribution generated by the first teacher machine learning model.

7. The computer-implemented method of claim 1, wherein the one or more gradients comprise one or more gradients of the loss with respect to at least one of one or more low-rank matrices included in the one or more LoRA towers or one or more rank channels included in the one or more the low-rank matrices.

8. The computer-implemented method of claim 1, wherein generating the one or more LoRA tower ranks comprises:
computing, based on one or more magnitudes of the one or more gradients, one or more saliency scores; and
generating, based on the one or more saliency scores, the one or more LoRA tower ranks.

9. The computer-implemented method of claim 8, wherein generating the one or more LoRA tower ranks further comprises applying an exponential moving average to the one or more saliency scores across one or more training steps.

10. The computer-implemented method of claim 1, wherein a total number of the one or more LoRA tower ranks is constrained by a budget.

11. The computer-implemented method of claim 1, further comprising:
receiving input data and a task;
selecting, based on a task identifier included in the task, a first LoRA tower included in the one or more LoRA towers; and
generating, based on the input data, output data using the first LoRA tower and the second machine learning model.

12. The computer-implemented method of claim 11, wherein selecting the first LoRA tower comprises mapping the task identifier to the first LoRA tower using at least one of:
a rule-based mapping; or
a learned routing mechanism.

13. The computer-implemented method of claim 1, wherein updating the one or more parameters of the one or more LoRA towers comprises updating, based on the loss and one or more LoRA tower ranks, one or more parameters of one or more channels with active rank included in the one or more LoRA towers.

14. One or more non-transitory computer-readable media storing instructions that, when executed by one or more processors, cause the one or more processors to perform the steps of:
generating, based on training data, first output data using a first teacher machine learning model included in one or more teacher machine learning models;
generating, based on the training data, second output data using the first machine learning model, wherein the first machine learning model comprises a second machine learning model and one or more low-rank adaptation (LoRA) towers;
calculating, based on the first output data and the second output data, a loss;
generating, based on the loss, one or more gradients;
generating, based on the one or more gradients, one or more LoRA tower ranks; and
updating, based on the loss and the one or more LoRA tower ranks, one or more parameters of the one or more LoRA towers.

15. The one or more non-transitory computer-readable media of claim 11, wherein each LoRA tower included in the one or more LoRA towers corresponds to a respective teacher machine learning model included in one or more teacher machine learning models.

16. The one or more non-transitory computer-readable media of claim 11, wherein each LoRA tower included in the one or more LoRA towers is inserted at one or more layers of the second machine learning model.

17. The one or more non-transitory computer-readable media of claim 11, wherein calculating the loss comprises calculating a Kullback-Leibler (KL) divergence between a probability distribution generated by the first machine learning model and a probability distribution generated by the first teacher machine learning model.

18. The one or more non-transitory computer-readable media of claim 11, wherein the one or more gradients comprise one or more gradients of the loss with respect to at least one of one or more low-rank matrices included in the one or more LoRA towers or one or more rank channels included in the one or more the low-rank matrices.

19. The one or more non-transitory computer-readable media of claim 11, wherein generating the one or more LoRA tower ranks comprises:
computing, based on one or more magnitudes of the one or more gradients, one or more saliency scores; and
generating, based on the one or more saliency scores, the one or more LoRA tower ranks.

20. A system, comprising:
one or more memories storing instructions, and
one or more processors that are coupled to the one or more memories and, when executing the instructions, are configured to:
generate, based on training data, first output data using a first teacher machine learning model included in one or more teacher machine learning models,
generate, based on the training data, second output data using the first machine learning model, wherein the first machine learning model comprises a second machine learning model and one or more low-rank adaptation (LoRA) towers,
calculate, based on the first output data and the second output data, a loss;
generate, based on the loss, one or more gradients,
generate, based on the one or more gradients, one or more LoRA tower ranks, and
update, based on the loss and the one or more LoRA tower ranks, one or more parameters of the one or more LoRA towers.
